(19) United States
(12) Patent Application Publication
(10) Pub. No.: US 2007/0054090 A1
(43) Pub. Date: Mar. 8, 2007

(54) Polymer blanket for use in multi-cavity molding operations

(76) Inventor: Anthony L. Rockwell, Pickerington, OH (US)

Correspondence Address: OWENS CORNING, 2790 COLUMBUS ROAD, GRANVILLE, OH, 43023, US

(21) Appl. No.: 10/989,613

(22) Filed: Nov. 16, 2004

(51) Int. Cl. D21J 3/00; B32B 3/10

(52) U.S. Cl. 428/136; 264/324; 264/40.1; 428/58

(57) ABSTRACT

A polymer blanket includes a body having a first molding panel, a second molding panel and a mesh section connecting the first and second molding panels. In addition a method of making a polymer blanket for use in multi-cavity molding operations includes the steps of determining how many cavities are in a multi-cavity mold, determining the required dimensions for each panel of polymer blanket to be molded in each cavity and forming a polymer blanket with a required panel of desired dimensions for each mold cavity and a mesh section for connecting the required panels together.

### TECHNICAL FIELD AND INDUSTRIAL APPLICABILITY OF THE INVENTION

The present invention relates generally to polymer blankets and, more particularly, to a polymer blanket particularly adapted for use in multi-cavity molding operations.

### BACKGROUND OF THE INVENTION

Perforated nonwoven fabrics of polymer material are well known in the art. Representative examples include U.S. Pat. No. 5,714,107 to Levy et al.; U.S. Pat. No. 4,615,671 to Bernal and U.S. Pat. No. 3,864,198 to Jackson. In each of these prior art patents the polymer material is slit or cut and then subjected to stretching to provide a honeycomb web or open cell structure across the entire width of the product. The blanket or fabric is then subsequently molded into a useful article.

Unlike the polymer material fabrics of these prior art patents, the present invention relates to a polymer blanket particularly suited for use in multi-cavity molding operations. More specifically, the body of the polymer blanket includes multiple molding panels connected together by a mesh section so that those panels are appropriately spaced to be received in the multiple cavities of the mold. The mesh connecting section includes large openings thereby reducing waste material and production costs.

### SUMMARY OF THE INVENTION

In accordance with the purposes of the present invention as described herein, a polymer blanket is provided. The polymer blanket comprises a body including a first molding panel, a second molding panel and a mesh section connecting the first molding panel to the second molding panel. The body is constructed from a polymer material including thermoplastic fibers, thermosetting fibers, both thermoplastic and thermosetting fibers and/or bicomponent fibers. More specifically, the body may be constructed from a polymer material selected from a group consisting of polyolefin, polyester, polypropylene, polyethylene, nylon, rayon, polyethylene terephthalate, polybutylene terephthalate and mixtures thereof. The polymer material may also include reinforcing fibers selected from a group consisting of glass fibers, metal fibers, mineral fibers, carbon fibers, graphite fibers, natural fibers and mixtures thereof. The reinforcing fibers typically have a diameter of between about 5 and about 50 microns and a length of between about 12.6 and 75.6 mm.

The mesh section includes a series of expandable expansion ribs. Each of the expansion ribs includes a first segment and a second segment. The first segment is connected to the second segment by a first living hinge. The first segment is also connected to the first molding panel by a second living hinge. Further, the second segment is connected to the second molding panel by a third living hinge. In an alternative embodiment the mesh section includes alternating rows of (a) straight slits and (b) openings with extension slits defining a four-way living hinge at a convergence of adjacent straight slits and said openings.

In one embodiment the body comprises an elongated web, such as a roll of blanket of material. In another possible embodiment the body comprises a blank of predetermined dimension particularly suited for feeding directly into a multi-cavity mold.

In accordance with another aspect of the present invention a method is provided for making a polymer blanket for use in multi-cavity molding operations. The method comprises the steps of determining how many cavities are in a multi-cavity mold, determining required dimensions for each panel of polymer blanket to be molded in each cavity and forming a polymer blanket with a required panel of desired dimensions for each mold cavity and a mesh section for connecting the required panels together. The method further includes constructing the polymer blanket from a polymer material including thermoplastic fibers, thermosetting fibers, both thermoplastic and thermosetting fibers and/or bicomponent fibers.

The method also includes the constructing of the polymer blanket from a polymer material selected from a group consisting of polyolefin, polyester, polypropylene, polyethylene, nylon, rayon, polyethylene terephthalate, polybutylene terephthalate and mixtures thereof. Still further the method may also include the step of adding reinforcing fibers to the polymer material and selecting the reinforcing fibers from a group consisting of glass fibers, metal fibers, mineral fibers, carbon fibers, graphite fibers, natural fibers and mixtures thereof.

Still further the method includes the making of the mesh section to include a series of expandable expansion ribs. Each expansion rib includes a first segment and a second segment as previously described.

In an alternative embodiment the method includes the making of the mesh section to include alternating rows of (a) straight slits and (b) openings with extension slits defining a four-way living hinge at a convergence of adjacent straight slits and said openings.

In accordance with yet another aspect of the present invention a method is provided for reducing waste material when molding a polymer blanket in a multi-cavity mold. That method includes the steps of providing the polymer blanket with a molding panel for each cavity in the mold and providing the polymer blanket with a mesh section connecting at least two of the molding panels together.

Still further, the present invention includes a method of charging a multi-cavity mold with a polymer blanket including multiple molding panels interconnected by a mesh section. Steps of this method include opening the multi-cavity mold, positioning one of the multiple molding panels for molding in or over each of the multiple cavities and closing the molding cavity. The positioning step includes expanding the mesh section of the polymer blanket so as to provide the necessary spacing between the multiple molding panels in order to properly position the multiple molding panels for molding in the cavities.

In the following description there is shown and described several possible embodiments of this invention simply by way of illustration of some of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is a schematical top plan view of the polymer blanket of the present invention prior to expansion of the mesh section between the first and second molding panels;

FIG. 2 is a schematical top plan view similar to FIG. 1 following expansion of the mesh section;

FIG. 3 is a schematical cross sectional view showing the positioning of the polymer blanket of the present invention in a multi-cavity mold;

FIGS. 4a and 4b are detailed top plan views of one possible embodiment of the mesh section of the polymer blanket in the pre-expanded and expanded conditions respectively; and

FIGS. 5a and 5b are top plan views of a second embodiment of the polymer blanket in the pre-expanded and expanded conditions respectively.

Reference will now be made in detail to the two possible embodiments of the invention illustrated in the accompanying drawings.

### DETAILED DESCRIPTION AND PREFERRED EMBODIMENTS OF THE INVENTION

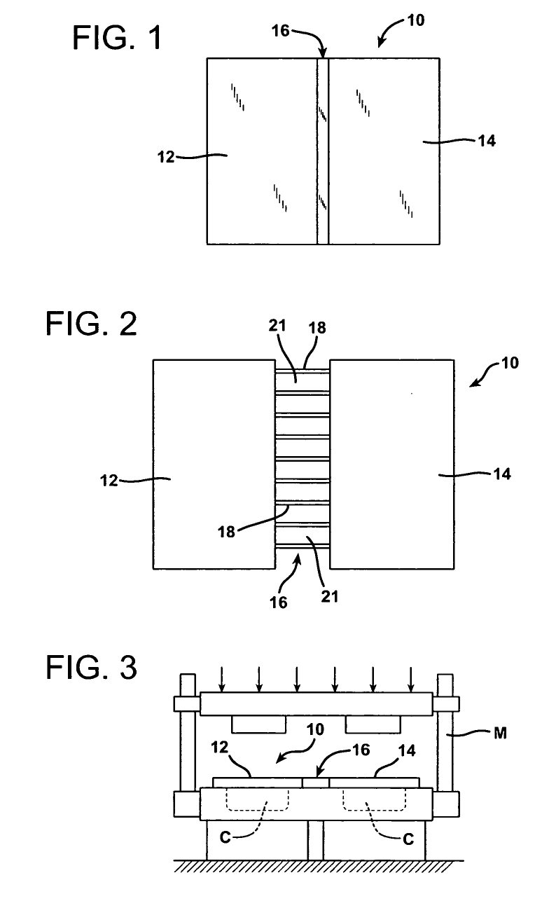

Reference is now made to FIG. 1 illustrating the polymer blanket 10 of the present invention. In the illustrated embodiment, the polymer blanket 10 includes a body having first molding panel 12, a second molding panel 14 and a mesh section 16 connecting the first and second molding panels together. Each molding panel 12, 14 is sized and shaped for receipt in a cavity of a multi-cavity mold into which the polymer blanket 10 is to be charged for production of a desired product. While only two molding panels 12, 14 are illustrated in the FIG. 1 embodiment of the polymer blanket 10, it should be appreciated that the polymer blanket may include substantially any number of molding panels consistent with the number of cavities in the multi-cavity mold for which the polymer blanket is made. Further, no matter how many molding panels 12, 14 are provided, a mesh section 16 may be provided between each of them so as to connect them all together.

The polymer blanket 10 may be constructed from substantially any polymer material including thermoplastic fibers, thermosetting fibers, both thermoplastic and thermosetting fibers and/or bicomponent fibers. Further, the polymer blanket 10 may be woven or nonwoven. The polymer blanket 10 may be constructed, for example, from polymer material selected from a group consisting of polyolefin, polyester, polypropylene, polyethylene, nylon, rayon, polyethylene terephthalate, polybutylene terephthalate and mixtures thereof. Further, the polymer material of the polymer blanket 10 may include reinforcing fibers. Reinforcing fibers may, for example, be selected from a group consisting of glass fibers, metal fibers, mineral fibers, carbon fibers, graphite fibers, natural fibers (e.g. cotton, hemp and kenaf) and mixtures thereof. Typically the reinforcing fibers have a diameter of between about 5 and about 50 microns and a length of between about 12.6 and 75.6 mm.

The mesh section 16 includes a series of expansion ribs 18. Thus, the mesh section 16 may be expanded or opened so that the polymer blanket 10 assumes a configuration illustrated in FIG. 2. As illustrated in FIG. 3 this allows the polymer blanket 10 of the present invention to be charged into a multi-cavity mold M with the molding panels 12, 14 properly positioned and oriented for molding in the cavities C of that mold. Of course, the open spaces 21 in the expanded mesh section 16 significantly reduce material waste and thereby substantially lower production costs.

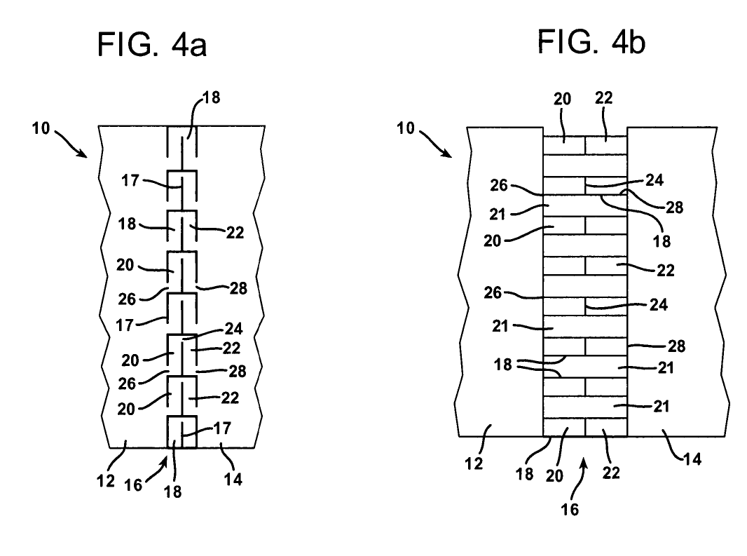

The expandable expansion ribs 18 of the mesh section 16 may be made in a number of different ways. One possible embodiment of the expansion ribs 18 is illustrated in FIGS. 4a and 4b.

As best illustrated in FIG. 4a, a series of branched slits 17 extend completely through the body of the polymer blanket 10 in the mesh section 16. As illustrated, each branched slit 17 is substantially Y-shaped and the series of branched slits at least partially nest with one another. It is these branched slits 17 that define each expansion rib 18. Each expansion rib 18 includes a first segment 20 and a second segment 22. The first segment 20 is connected end-to-end with the second segment 22 by a first living hinge 24. The opposite end of the first segment 20 is connected to a first molding panel 12 by a second living hinge 26. Similarly, a third living hinge 28 connects the opposite end of the second segment 22 to the second molding panel 14.

FIG. 4b shows the expanding of the mesh section 16. More specifically, each of the expansion ribs 18 is folded along the first, second and third living hinges 24, 26, 28 so that the first and second molding panels 12, 14 are separated and the expansion ribs 18 are erected to extend straight between the two molding panels. As a result, a series of open spaces or cells 21 are provided between adjacent expansion ribs 18 and the molding panels 12, 14. Depending upon the size of the branched slits 17, the area covered by the geometric pattern of the expanded mesh section 16 compared to the original area of that same section can be increased by perhaps 150 to 500%.

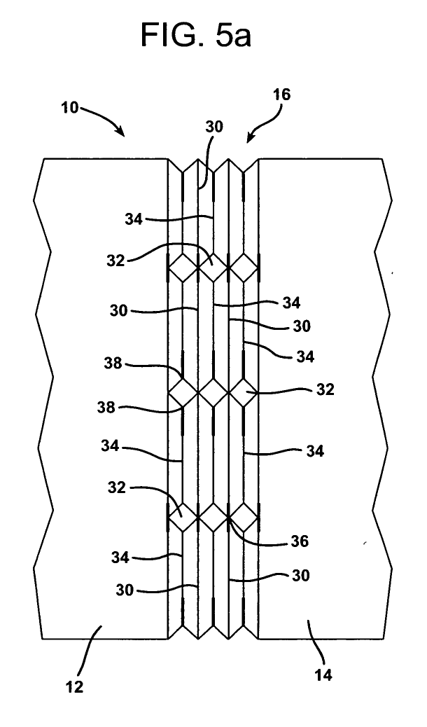

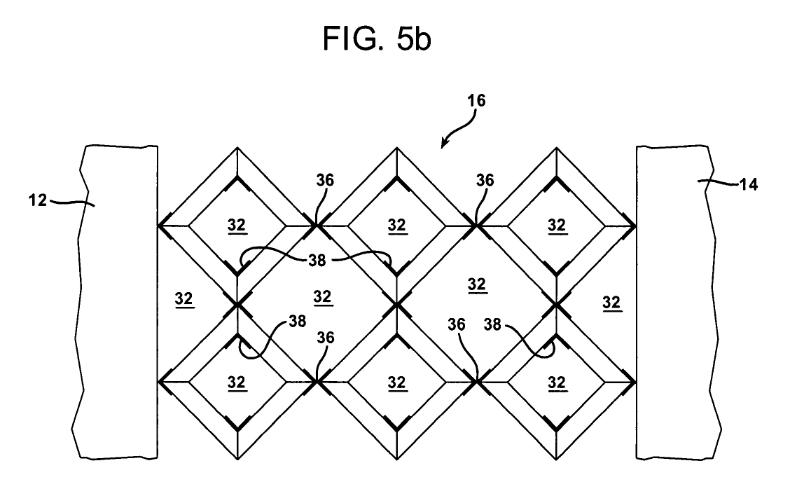

An alternative embodiment of the polymer blanket 10 is illustrated in FIGS. 5a and 5b. In this embodiment the mesh section 16 includes alternating rows of (a) straight slits 30 and (b) openings 32 with extension slits 34 defining a four-way living hinge 36 at a convergence of adjacent slits and openings. This embodiment is expanded into the position illustrated in FIG. 5b by folding the mesh section 16 about the four-way living hinges 36 provided at the convergence of adjacent straight slits 30 and openings 32 and the additional living hinges 38 provided at opposing corners of alternating openings 32 that do not define four-way living hinges 36.

The polymer blanket 10 of the present invention is relatively easily produced. More specifically, polymer material is fed from a roll or directly from a forming station through a rotary die cutter that cuts the nested, branched slits 17 or the straight slits 30 and cooperating openings 32 in the mesh section 16. The polymer blanket 10 may then be cut into a blank of predetermined dimension for charging directly into a mold or maintained as an elongated web in roll form.

Where the polymer blanket 10 is to be subsequently shipped to a different site for molding, the mesh section 16 is maintained in the unexpanded condition illustrated in FIGS. 1, 4a and 5a. Obviously, the unexpanded blanket requires less space or volume for shipping. The polymer blanket 10 can then be expanded on site before being placed into the mold for final product production.

In accordance with another aspect of the present invention, a method is provided for making a polymer blanket for use in multi-cavity molding operations. The method comprises determining how many cavities are in the multi-cavity mold to which the polymer blanket is being made. In addition the method includes the step of determining the required dimensions for each molding panel 12, 14 of the polymer blanket 10 to be molded in each cavity C. This is followed by the forming of the polymer blanket 10 with the required panels 12, 14 of desired dimensions for each mold cavity C and a mesh section 16 for connecting the required panels together.

The polymer blanket 10 of the present invention is easily charged into a multi-cavity mold. First is the opening of the multi-cavity mold. This is followed by the positioning of one of the multiple molding panels 12, 14 in or over each of the multiple cavities C of the mold M. More specifically, this positioning step includes expanding the mesh section 16 of the polymer blanket 10 so as to provide the necessary spacing between the multiple molding panels 12, 14 in order to properly position the multiple molding panels for molding. Thus, it should be appreciated that the mesh section 16 is explicitly designed so that when expanded as illustrated in FIGS. 2, 4b and 5b, the molding panels 12, 14 are precisely spaced for molding in the cavities C of the mold M. After properly positioning the panels 12, 14 relative to the mold cavity C, the multi-cavity mold is closed and final products are molded. Following molding, the mesh section 16 is trimmed or cut from the molded products.

In summary, numerous benefits result from employing the concepts of the present invention. By providing a mesh section 16 with open spaces 21 or 32 between the molding panels 12, 14, there is less waste of polymer material. Accordingly, production costs are advantageously reduced.

Other significant benefits are also derived from the present invention. More specifically, by shipping the polymer blanket 10 in an unexpanded condition as illustrated in FIGS. 1, 4a and 5a, the shipping volume of the polymer blanket is significantly reduced. Further, since less material is utilized to make the polymer blanket, the weight of the polymer blanket is also reduced thereby beneficially reducing shipping costs.

In addition, it should be appreciated that many materials, such as high loft nonwoven materials, have a tendency to undergo thinning in deep draw areas during deep draw molding. The present invention allows one to significantly reduce this undesirable effect. More specifically, the mesh section 16 allows one to control the tension of the polymer blanket 10 across the tool face when it is charged into the mold M. Further, by cutting the hinges 24, 26, 28, 36 and 38 away in specific areas as the mold M closes, the polymer blanket 10 can be made to better conform to the desired shape while reducing this thinning.

The foregoing description of the preferred embodiments of the invention have been presented for purposes of illustration and description. It is not intended to be exhaustive or to limit the invention to the precise form disclosed. Obvious modifications or variations are possible in light of the above teachings. For example, while the polymer blanket 10 illustrated in the drawing figures is a single layer structure, it should be appreciated that the polymer blanket could be a multilayer structure including a multilayer laminate of the same or different materials. Further, it should be appreciated that the present invention may be utilized to mold variable geometrically shaped parts that may be nested in one blank.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed:

1. A polymer blanket, comprising:
a body including a first molding panel, a second molding panel and a mesh section connecting said first molding panel to said second molding panel.

2. The polymer blanket of claim 2 wherein said body is constructed from a polymer material including thermoplastic fibers.

3. The polymer blanket of claim 1, wherein said body is constructed from a polymer material including thermosetting fibers.

4. The polymer blanket of claim 1, wherein said body is constructed from a polymer material including both thermoplastic and thermosetting fibers.

5. The polymer blanket of claim 1, wherein said body is constructed from a polymer material including bicomponent fibers.

6. The polymer blanket of claim 1, wherein said body is constructed from a polymer material selected from a group consisting of polyolefin, polyester, polypropylene, polyethylene, nylon, rayon, polyethylene terephthalate, polybutylene terephthalate and mixtures thereof.

7. The polymer blanket of claim 6, wherein said polymer material includes reinforcing fibers selected from a group consisting of glass fibers, metal fibers, mineral fibers, carbon fibers, graphite fibers, natural fibers and mixtures thereof.

8. The polymer blanket of claim 7, wherein said reinforcing fibers have a diameter of between about 5 and about 50 microns and a length of between about 12.6 and 75.6 mm.

9. The polymer blanket of claim 1, wherein said mesh section includes a series of expandable expansion ribs.

10. The polymer blanket of claim 9, wherein each said expansion rib includes a first segment and a second segment, said first segment being connected to said second segment by a first living hinge, said first segment being connected to said first molding panel by a second living hinge and said second segment being connected to said second molding panel by a third living hinge.

11. The polymer blanket of claim 1, wherein said mesh section includes alternating rows of (a) straight slits and (b) openings with extension slits defining a four-way living hinge at a convergence of adjacent straight slits and said openings.

12. The polymer blanket of claim 1, wherein said body comprises an elongated web.

13. The polymer blanket of claim 1, wherein said body comprises a blank of predetermined dimension.

14. A method of making a polymer blanket for use in multi-cavity molding operations, comprising:
determining how many cavities are in a multi-cavity mold;
determining required dimensions for each panel of polymer blanket to be molded in each cavity; and
forming a polymer blanket with a required panel of desired dimensions for each mold cavity and a mesh section for connecting said required panels together.

15. The method of claim 14 further including constructing said polymer blanket from a polymer material including thermoplastic fibers.

16. The method of claim 14 further including constructing said polymer blanket from a polymer material including thermosetting fibers.

17. The method of claim 14 further including constructing said polymer blanket from a polymer material including thermoplastic and thermosetting fibers.

18. The method of claim 14 further including constructing said polymer blanket from a polymer material including bicomponent fibers.

19. The method of claim 14 further including constructing said polymer blanket from a polymer material selected from a group consisting of polyolefin, polyester, polypropylene, polyethylene, nylon, rayon, polyethylene terephthalate, polybutylene terephthalate and mixtures thereof.

20. The method of claim 19 further including adding reinforcing fibers to said polymer material and selecting said reinforcing fibers from a group consisting of glass fibers, metal fibers, mineral fibers, carbon fibers, graphite fibers, natural fibers and mixtures thereof.

21. The method of claim 14 further including making said mesh section to include a series of expandable expansion ribs.

22. The method of claim 21, further including making each said expansion rib to include a first segment and a second segment, said first segment being connected to said second segment by a first living hinge, said first segment being connected to said first molding panel by a second living hinge and said second segment being connected to said second molding panel by a third living hinge.

23. The method of claim 14, further including making said mesh section to include alternating rows of (a) straight slits and (b) openings with extension slits defining a four-way living hinge at a convergence of adjacent straight slits and said openings.

24. A method of reducing waste material when molding a polymer blanket in a multi-cavity mold, comprising:
providing said polymer blanket with a molding panel for each cavity in said mold; and
providing said polymer blanket with a mesh section connecting at least two of said molding panels together.

25. A method of charging a multi-cavity mold with a polymer blanket including multiple molding panels interconnected by a mesh section, said method comprising:
opening said multi-cavity mold;
positioning one of said multiple molding panels for molding in each of said multiple cavities; and
closing said multi-cavity mold.

26. The method of claim 25, wherein said positioning step includes expanding said mesh section of said polymer blanket so as to provide necessary spacing between said multiple molding panels in order to properly position said multiple molding panels for molding in said multiple cavities.
